(19) United States
(12) Patent Application Publication
(10) Pub. No.: US 2013/0075046 A1
(43) Pub. Date: Mar. 28, 2013

(54) FOLDING WINDOW COVERING

(71) Applicant: John Trousdale, Edison, NJ (US)

(72) Inventor: John Trousdale, Edison, NJ (US)

(21) Appl. No.: 13/246,087

(22) Filed: Sep. 27, 2011

(51) Int. Cl. A47H 23/02; E06B 9/28

(52) U.S. Cl. 160/84.08; 160/166.1; 160/405

(57) ABSTRACT

A folding window covering is constructed in a manner that reflects sunlight and blocks air currents through the window opening. The covering is attached to the window frame using magnetic coupling. The folding action is supported by magnetic coupling of the individual panels that constitute the window covering, allowing the system to be opened partially. The panels may contain an insulating layer to reduce heat transfer through conduction.

### FIELD OF THE INVENTION

This invention relates to improved methods and apparatus concerning windows and window treatments.

### BACKGROUND OF THE INVENTION

Window treatments are used for decoration, for privacy, and for temperature control. The control of temperature is achieved through a reduction of heat transfer through radiation, convection or conduction. In warmer climates and at sunnier periods of the year, heat gain can be managed by placing a reflective layer over the window, thereby reducing or eliminating the amount of sunlight entering the space. Heat gain can be further reduced by reducing the air flow from the window to the interior of the space and by placing an insulating material over the window opening. In cooler climates and at colder periods of the year, similar strategies can be used to reduce heat loss from the interior space. For the retention of heat inside the space, placement of an air tight barrier across the window opening and of an insulating material over the opening provides a reduction in heat loss through convection and conduction.

Many window coverings have been designed with the goal of controlling temperature through the methods described above. However, many fall short due to the compromises that are made in order to retain an element of aesthetics or because they lack any aesthetics and are unattractive to potential users. Designers and manufacturers tend to follow one of two approaches: add insulating or reflective layers to existing window covering designs or take a sheet of reflective insulating board and try to make it look less industrial. The former approach results in a heavy, expensive product that is only partially effective. The latter approach may lead to a product that works from a mechanical perspective but it invariably leads to a cumbersome design that consumers will not buy.

### SUMMARY OF THE INVENTION

One or more embodiments of the present invention include a window covering that provides an effective barrier to heat loss through radiation, convection and conduction while providing the ability to allow light into a space when desired and also satisfying users' needs for an aesthetically pleasing solution. One or more embodiments of the present invention significantly reduce the amount of energy consumed heating and cooling residential and commercial buildings, resulting in cost savings for users and in a reduction in the creation of pollution from energy generation.

### BRIEF DESCRIPTION OF THE DRAWINGS

FIG. 1 illustrates a front view of a window from an interior space of a building without a window covering in place;

FIG. 2 illustrates a front view of the window of FIG. 1 with a window covering in place and fully deployed or fully closed

FIG. 3 illustrates a front view of the window of FIG. 1 from the interior space with the window covering in place and partially opened;

FIG. 4 shows a left side view of the window covering of FIG. 2 in a first state;

FIG. 5 shows a left side view of the window covering of FIG. 2 in a second state a;

FIG. 6a illustrates a cross sectional side view of the window of FIG. 1 with the window covering of FIG. 2 in place and fully deployed as in FIG. 2;

FIG. 6b illustrates the layers of the window covering of FIG. 2

FIG. 7a illustrates a front view of the window of FIG. 1 from the interior space with a window covering in place which incorporates a fabric layer incorporated into the window covering;

FIG. 7b illustrates a side, top, front view of a portion of layers of the window covering incorporating a fabric layer of FIG. 7a;

FIG. 8a illustrates a front view of the window of FIG. 1 from the interior space with a window covering in place which incorporates a picture layer;

FIG. 8b illustrates a side, top, front view of a portion of layers of the window covering incorporating a picture layer of FIG. 8a;

FIG. 9a illustrates a front view of the window of FIG. 1 from the interior space with a window covering in place, which incorporates a flexible insulating layer; and

FIG. 9b illustrates a side, top, front perspective view of a portion of the layers of the window covering incorporating a flexible insulating layer.

### DETAILED DESCRIPTION OF THE DRAWINGS

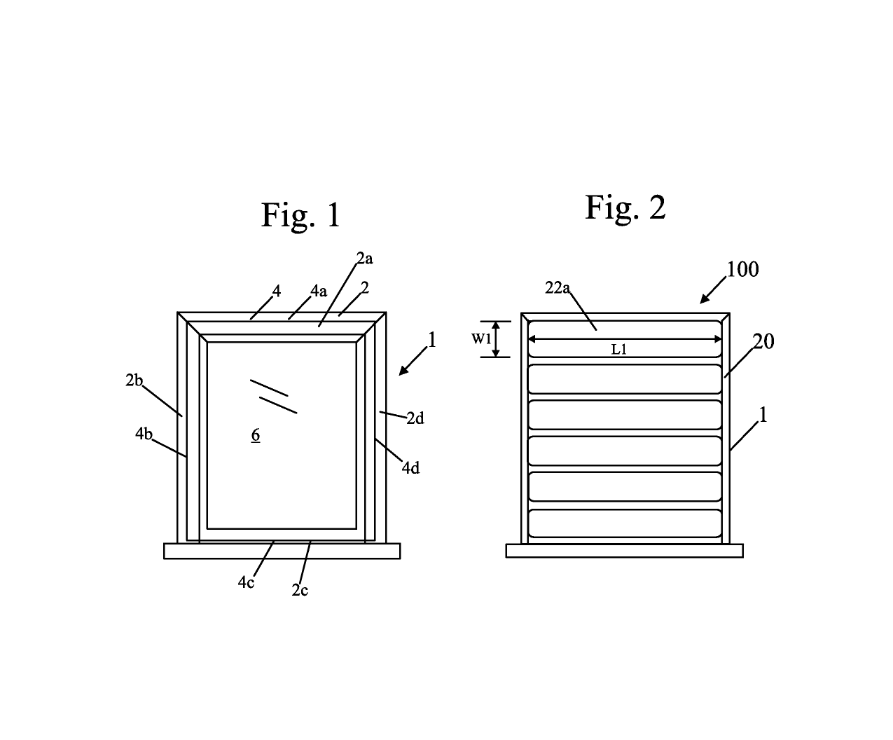

FIG. 1 illustrates a front view of a window 1 from an interior space of a building without a window covering in place. The window 1 includes a window frame 2, a magnetic material 4, and glass 6. The magnetic material 4 includes top strip 4a, side strips 4b and 4d, and bottom strip 4c. The magnetic material 4 may be a ferromagnetic material which may be mounted to the window frame 2, such as for example by using an adhesive and/or screws.

FIG. 2 illustrates a front view of the window 1 with a window covering 20 in place and fully deployed or fully closed. The combination of the window 1 and the window covering 20 is identified as an apparatus 100.

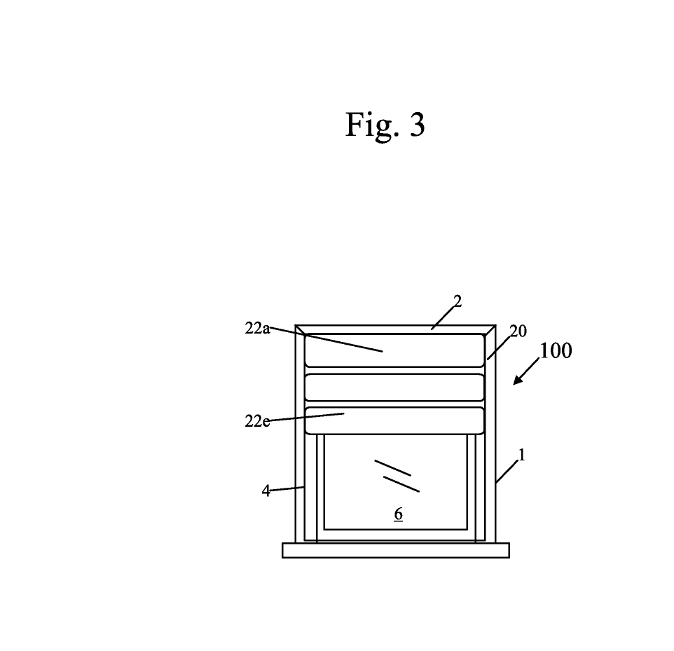

FIG. 3 illustrates a front view of the window 1 from the interior space with the window covering 20 in place and partially opened.

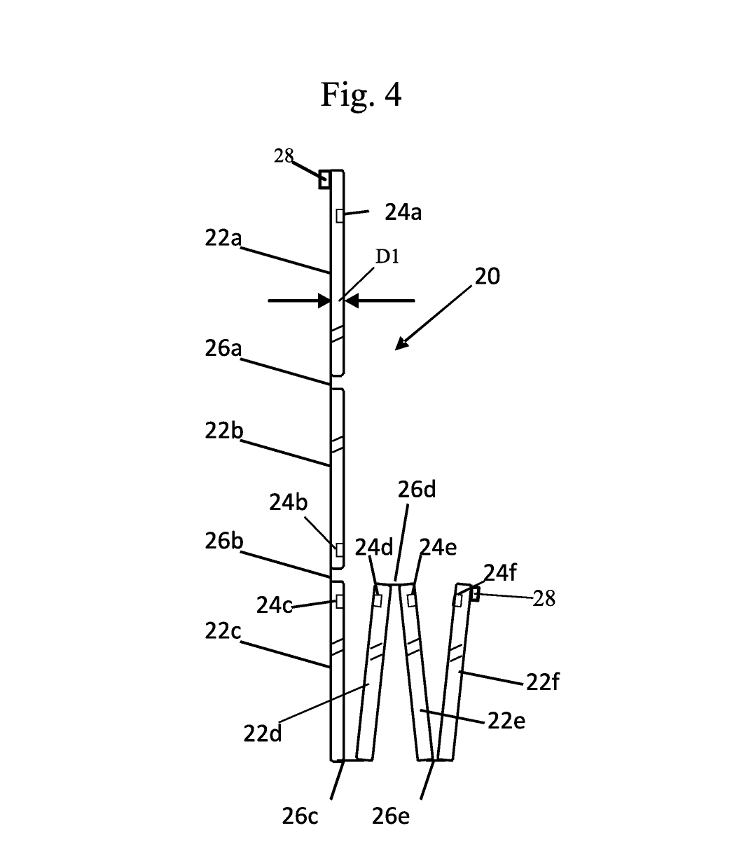

FIG. 4 shows a left side view of the window covering 20 of FIG. 2 in a first state. The window covering 20 includes panels 22a, 22b, 22c, 22d, 22e, and 22f. The panels 22a, 22b, 22c, 22d, and 22f may be built into the structure of the window covering 20, and may constitute sections of the coverings that may be folded over one another concertina style in order to close or partially close the covering 20. The sections of the window covering 20 that do not contain solid panels, identified as components 26a, 26b, 26c, 26d, and 26e, are flexible and so allow the folding action to take place. The window covering 20 contains magnetic components 24a, 24b, 24c, 24d, 24e, and 24f that can be attached to one another to keep window covering 20 in a closed or partially closed position. For example, components 24a, 24c and 24e may have a south magnetic pole and attach to component 24b, 24d, and 24f respectively which may have a north magnetic pole.

Panel 22a has a width W1, and a length L1, shown in FIG. 2. Panel 22a also has a depth of D1 shown in FIG. 4. Typically, the length L1 is substantially greater than the width W1 and both the length L1 and the width W1 are substantially greater than the depth D1. For example, the length L1 may be thirty-six inches, the width W1 may be six inches and the depth D1 may be 0.33 inches. The width W1 and the length L1 define an area of the panel 22a, which in one state can substantially or completely overlap analagous areas of one or more of the other panels 22b-f. Each of the panels 22b-f may be identical to the panel 22a.

FIG. 5 shows a left side view of the window covering 20 of FIG. 2 in a second state with element 24c attached to 24d and element 24e attached to element 24f.

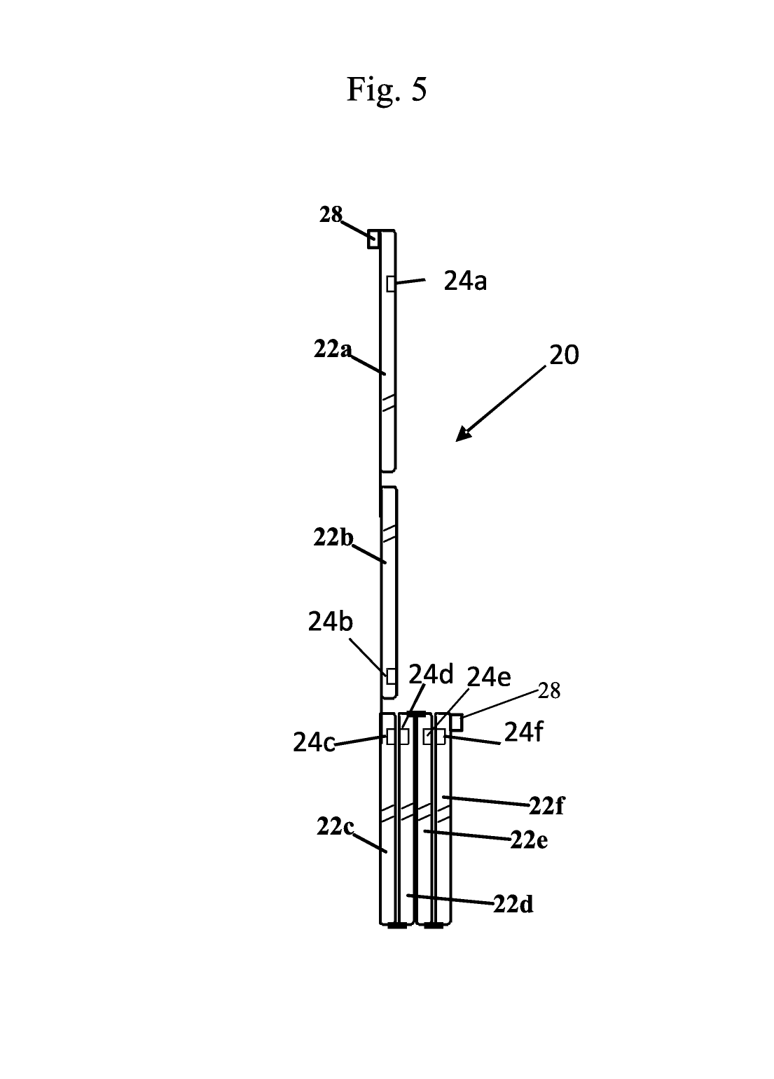

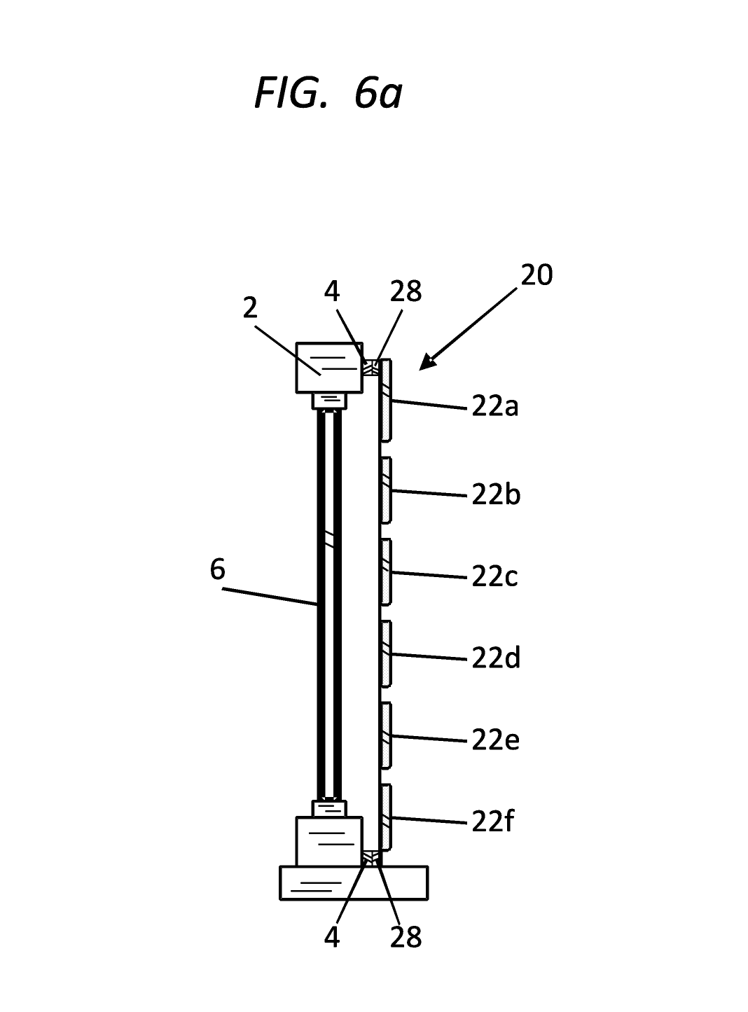

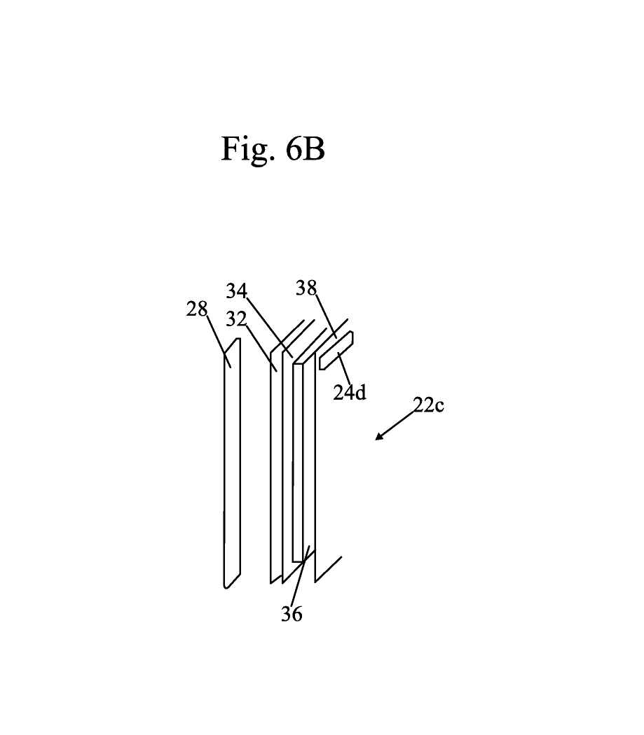

FIG. 6A illustrates a cross sectional side view of the window 1 of FIG. 1 and the window covering 20 with the window covering 20 in place and fully deployed as in FIG. 2.

FIG. 6B illustrates a left side, top, front perspective view of a portion of the layers of the window covering 20 of FIG. 2.

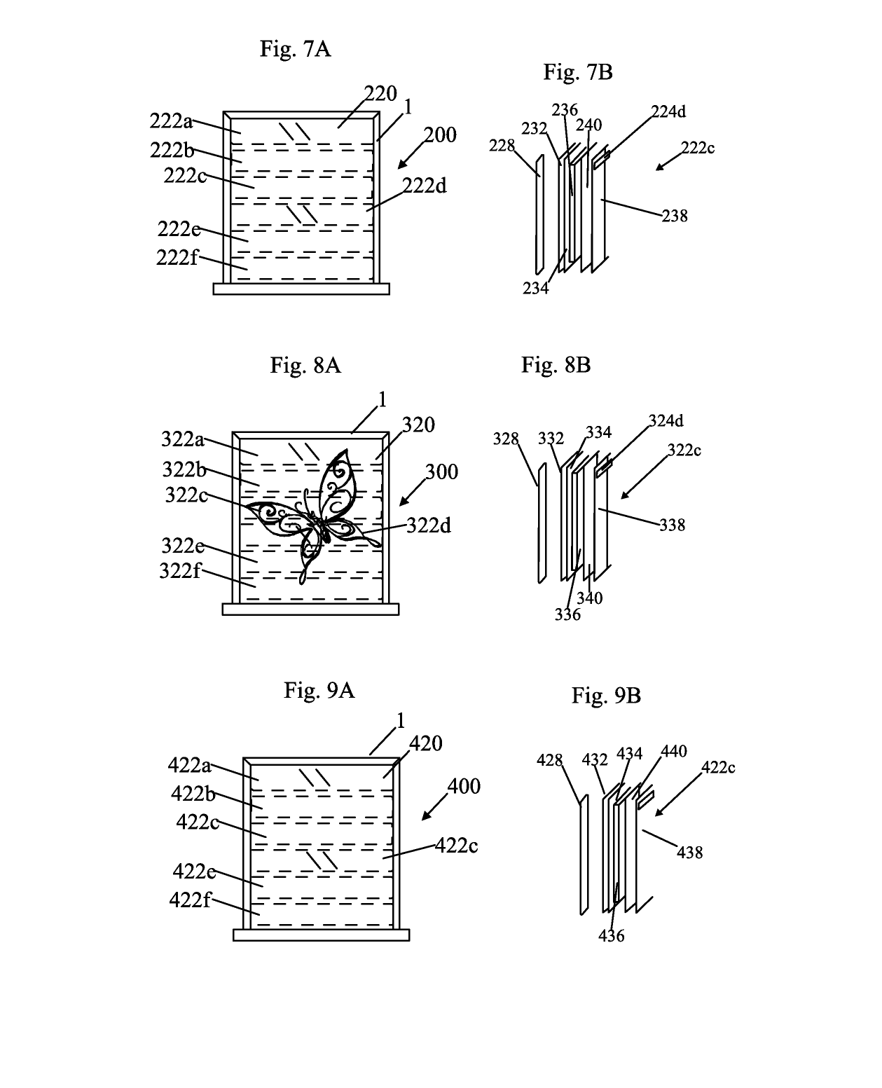

FIG. 7A illustrates a front view of an apparatus 200 including the window 1 and a window covering 220 in place which incorporates a fabric layer.

FIG. 7B illustrates a side, top, front view of a portion of layers of the window covering 220.

FIG. 8A illustrates a front view of an apparatus 300 which includes the window 1 with a window covering 320 in place which incorporates a picture layer.

FIG. 8B illustrates a side, top, front view of a portion of layers of the window covering 320 incorporating a picture layer of FIG. 8A.

FIG. 9A illustrates a front view of an apparatus 420, which includes the window 1 and a window covering 420 in place, which incorporates a flexible insulating layer.

FIG. 9B illustrates a side, top, front perspective view of a portion of the layers of the window covering 420 incorporating a flexible insulating layer.

The window coverings 20 of FIG. 2, 220 of FIG. 7A, 320 of FIG. 8A, and 420 of FIG. 9A, can be attached to the window frame 2 of the window 1 using magnetic coupling. For example magnetic strip or material 28 may be attached magnetically to magnetic material 4 of window 1. FIG. 6A shows piece 28 magnetically attached to material 4 at the top and bottom of the window frame 2. Magnetic strip 28 typically extends to the top, bottom and sides of the window covering 20 and aligns with material 4 so that window covering 20, 220, 330, and 420 seals to the window around its outside edge when fully deployed. The use of magnetic coupling allows for the complete removal or reattachment of a particular window covering in a few seconds without the use of tools. The windows coverings 20, 220, 320, and 420 can be magnetically attached to window 1 magnetically to provide temporary insulation when needed in summer and winter, and detached from window 1 and stored during the spring and fall. FIG. 1 illustrates the window frame 2 with magnetic material 4 fixed to the frame 2, such as by using an adhesive, such as a permanent adhesive. The material 4 may be a ferromagnetic strip. In at least one embodiment, the material 4 does not interfere with the view through the glass 6 of the window 1. To facilitate the attachment of a window covering, such as one of 20, 220, 320, and 420 to the window frame 2, the magnetic or ferromagnetic material 4 is attached to all four inward facing sides, such as sides 2a, 2b, 2c, and 2d of the window frame 2 in a position that allows the material 4 to make contact with magnetic material 28 that lines the exterior face of the particular window covering.

In its closed position, as shown in FIG. 2, the window covering, such as 20 attaches to the window frame 2 providing a barrier to light and air flow, through the window 1. The window covering 20 also provides a barrier to the conduction of heat through the panels 22a-f, which may be made of insulating material.

In a partially open position of the window covering 20 shown in FIG. 3, which can be achieved in at least one embodiment by flipping panels, of panels 22a-22e, so they attach to those higher in the assembly, the window covering 20 reflects some of the light reaching the window opening. For example piece 24c can be attached to piece 24d, and 24e to 24f magnetically to shorten the length of the window covering 20, as shown in FIG. 5 and FIG. 3, and allow some light through the glass 6 of the window 1 as shown in FIG. 3.

FIG. 3 illustrates the view of the window 1 with the covering 20 configured so that panels 22c, 22d, 22e, and 22f are attached by magnetic pieces 24c, 24d, 24e, and 24f. The amount of light allowed through the glass 6 of the window 1 can be controlled by folding or unfolding panels of panels 22a-f of the window covering 20. When fully folded, the window covering 20 will take up only a fraction of the window opening of area shown by glass 6 in FIG. 1, consistent with the space taken up with traditional horizontal blinds when in their most compact position. The magnetic or ferromagnetic material 4 on the window frame 2, is in partial contact with the window covering 20 in this position. The sections of the window covering 20 that are folded, such as 22c-f are held in place through magnetic coupling.

FIG. 4 illustrates a mechanism by which the window covering 20 stays in plays in its open or partially open position. Each of pieces 24a-f may be magnetic tape or similar magnetic material and may be attached or imbedded on the face of individual sections or panels of the window covering 20, as shown in FIG. 4, such that north and south magnetic poles or components are in contact when the panels 22a-e are folded. For example, in FIG. 5, if piece 24f has a north magnetic pole facing piece 24e, then piece 24e has a south magnetic pole facing piece 24f and attracting piece 24f. Similarly, if piece 24e has a north magnetic pole facing piece 24d then piece 24d has a south magnetic pole facing and attracting piece 24e. If piece 24d has a north magnetic pole facing and attracting piece 24c, then piece 24c has a south magnetic pole facing and attracting piece 24d. The panels 22a-e stay in place through the resulting magnetic coupling.

The side of the window covering 20 that faces the exterior of a building is lined with magnetic tape or similar magnetic material FIG. 5A illustrates the window frame 2 of the window 1 in cross section showing the magnetic or ferromagnetic strip 4 on the window frame 2 and its contact with a magnetic strip 28 attached to the inside edge of the window covering 20 shown in FIG. 6A. While FIG. 6A shows only a slice through the window opening or through glass 6, it should be understood that the magnetic or ferromagnetic strip 4 on the window frame 2 typically runs continuously around the window frame 2 as shown in FIG. 1 and the magnetic strip 28 on the window covering 20 runs continuously around the window covering 20, providing a continuous seal around the window frame 2.

FIG. 6B illustrates the layers of a panel or section 22c of the window covering 20 as seen from a side perspective. The first component is the magnetic strip 28 that runs around the edge of the covering 20 and makes contact with the magnetic or ferromagnetic strip or material 4 on the window frame 2. Section 22c is shown but the other sections of 22a-b, and 22d-f may be identical or similar to the section 22c, with the exception of locations and magnetic directions of pieces 24a-24f which are arranged so that the panels or sections 22a-e can be folded up as described with respect to FIG. 4. Next is a clear vinyl sheet 32 that protects a reflective layer 34 from damage. The reflective layer 34 is made from an uninterrupted sheet of foil and is used to reflect radiated heat and light that enter the window opening through glass 6. The next layer 36 is a panel made of foam board or other insulating material. The next layer 38 is made of vinyl or similar plastic and provides a vapor barrier and protection to the panel 36 and foil layer 34. The layer 38 may be said to represent the interior skin of the panel or section 22c and together with other panels 22a-b, and 22d-f, the interior skin of the window covering 20. The final component of the construction is the magnetic piece 24c that is attached to the edge of the panel 22c to enable the panel 22c to stay in a folded position, as illustrated in FIG. 4. Note that, in at least one embodiment of the present invention, layers 28, 32, 34 and 38 run continuously through the window covering 20 and that the limits of section 22c are defined by the limits of the panel 36.

The layers and/or components 28, 32, 34, 36, 38, and 24d (for section 22c) are bonded using adhesive or heat in order to maintain the integrity of the vapor barrier and to avoid creating a medium for conducting heat. An additional layer may be added to section 22c (and to the other sections 22a-b, and 22d-f) for decorative purposes. This additional layer could be placed on the outside of the vinyl to provide a softer texture or it could consist of a paper layer that is placed between the panels 22a-f and a clear vinyl layer, providing the ability to display a pattern or picture to the interior space.

FIG. 7Aa illustrates a view of the window 1 with a window covering 220 in place that incorporates a textured layer 240, shown in FIG. 7B, such as fabric. The window covering 220 includes a plurality of panels, such as panels 222a, 222b, 222c, 222d, 222e, and 222f, each of which may be identical, except for placement of magnetic pieces similar to as described with reference to window covering 20.

FIG. 7B illustrates how the textured layer 240 would be incorporated into the panel 222c of overall structure of the window covering 220. The basic structure would not change, from the window covering 20, other than the addition of the textured layer 240 on the interior face and placement of the magnetic material 228 on the resulting surface. FIGS. 8a and 8B provide similar views to FIG. 7A and 7B but in this case a window covering 320 is provided to include a paper layer 340 shown in FIG. 8B rather than a textured layer. The paper layer 340 is sandwiched between the rigid panel 336 and an interior vinyl layer 338. Given that the picture is to be seen, the vinyl layer 338 has to be clear in this embodiment. The window covering 320 includes a plurality of panels, such as panels 322a, 322b, 322c, 322d, 322e, and 322f, each of which may be identical, except for placement of magnetic pieces similar to as described with reference to window covering 20.

A further embodiment is to add an insulating layer made of a flexible material such as Thinsulate (trademarked) in order to further reduce heat transfer through glass 6 of window 1 through conduction. This is illustrated in FIGS. 9A and 9B. The insulating layer 440 is incorporated between the rigid vinyl panel 436 and interior vinyl layer 438. This would not require the use of clear vinyl and so the view from the interior of the space would be of a window covering 420 that looked the same as if there was no flexible insulating layer 440. The window covering 420 includes a plurality of panels, such as panels 422a, 422b, 422c, 422d, 422e, and 422f, each of which may be identical, except for placement of magnetic pieces similar to as described with reference to window covering 20.

These additional components can also be combined, such as incorporating a flexible insulation layer, such as 440 and a fabric layer, such as 240.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

I claim:

1. An apparatus comprising:
a window covering comprising
a plurality of panels, each of the plurality of panels having a width, a length, and a depth, wherein the width and the length are substantially greater than the depth;
wherein the plurality of panels are connected together as a unit;
wherein the width and the length of each of the plurality of panels defines an area of each of the plurality of panels;
wherein each of the plurality of panels is connected to at least one other panel of the plurality of panels in a manner which allows the plurality of panels to be placed in a first state or in a second state;
wherein in the first state, the area of each of the plurality of panels does not overlap the area of any other panel of the plurality of panels; and
wherein in the second state, the area of at least one of the plurality of panels substantially overlaps the area of at least one other panel of the plurality of panels;
wherein at least one of the plurality of panels includes a first material; and
further comprising a second material adapted to be fixed to a window frame; and
wherein the window covering is configured to be attached to the window frame, at least in part, by the first material being magnetically attached to the second material, while the plurality of panels are in the first state or the second state.

2. The apparatus of claim 1 wherein
at least a first panel of the plurality of panels includes a third material;
at least a second panel of the plurality of panels includes a fourth material;
wherein in the second state the third material is magnetically attached to the fourth material to hold the first panel and the second panel in a position with respect to each other, so that the area of the first panel substantially overlaps the area of the second panel.

3. The apparatus of claim 1 wherein
at least one of the plurality of panels has a surface having an image.

4. The apparatus of claim 1 wherein
the image is a photographic image.

5. The apparatus of claim 1 wherein
each of the plurality of panels is connected to at least one other panel of the plurality of panels by a flexible member which can be folded to cause the area of each of the plurality of panels to substantially overlap the area of the panel to which each of the plurality of panels is connected.

6. A method comprising
magnetically attaching a window covering to a window frame;
wherein the window covering comprises
a plurality of panels, each of the plurality of panels having a width, a length, and a depth, wherein the width and the length are substantially greater than the depth;
wherein the plurality of panels are connected together as a unit;
wherein the width and the length of each of the plurality of panels defines an area of each of the plurality of panels;
wherein each of the plurality of panels is connected to at least one other panel of the plurality of panels in a manner which allows the plurality of panels to be placed in a first state or in a second state;
wherein in the first state, the area of each of the plurality of panels does not overlap the area of any other panel of the plurality of panels; and
wherein in the second state, the area of at least one of the plurality of panels substantially overlaps the area of at least one other panel of the plurality of panels;
wherein at least one of the plurality of panels includes a first material; and further comprising a second material adapted to be fixed to a window frame; and
wherein the window covering is attached to the window frame, at least in part, by the first material being magnetically attached to the second material, while the plurality of panels are in the first state or the second state.

7. The method of claim 6 wherein
at least a first panel of the plurality of panels includes a third material;
at least a second panel of the plurality of panels includes a fourth material;
wherein in the second state the third material is magnetically attached to the fourth material to hold the first panel and the second panel in a position with respect to each other, so that the area of the first panel substantially overlaps the area of the second panel.

8. The method of claim 6 wherein
at least one of the plurality of panels has a surface having an image.

9. The method of claim 6 wherein
the image is a photographic image.

10. The method of claim 6 wherein
each of the plurality of panels is connected to at least one other panel of the plurality of panels by a flexible member which can be folded to cause the area of each of the plurality of panels to substantially overlap the area of the panel to which each of the plurality of panels is connected.
